(19) United States
(12) Patent Application Publication
(10) Pub. No.: US 2008/0164106 A1
(43) Pub. Date: Jul. 10, 2008

(54) Electric Brake for Utility Vehicles

(75) Inventors: Warren Clark, Evans, GA (US); Oliver A. Bell, Aiken, SC (US); Aric Singletary, Hephzibah, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/619,805

(22) Filed: Jan. 4, 2007

(51) Int. Cl. F16D 55/224; G06F 19/00

(52) U.S. Cl. 188/73.31; 701/70

(57) ABSTRACT

An electric braking system and methods for a utility vehicle is provided. The system includes a rotor coupled to a rear axle of the utility vehicle. A caliper is electrically controlled to provide stopping force to the rotor. A spring is pre-loaded to actuate the caliper when additional stopping force is needed. A controller controls the activation of the caliper by generating an electrical braking signal to control operation of the caliper based on a brake position signal generated from a brake pedal position sensor.

### FIELD

The present teachings relate to electric braking systems and methods for utility vehicles.

### BACKGROUND

Utility vehicles, such as maintenance vehicles, cargo vehicles, shuttle vehicles, and golf cars typically employ mechanically or hydraulically actuated type brake assemblies for providing braking functions. The most common types of brake assemblies for gas utility vehicles include drum brakes and disc brakes. Drum brakes consist of shoes that press against a spinning surface called a drum. Disc brakes consist of a caliper that squeezes brake pads against a rotor. Hydraulic fluid can be supplied to hydraulic actuators of either one of the aforementioned brake assemblies. Additionally, mechanical forces can be supplied to mechanical actuators of either one of the aforementioned brake assemblies.

Both hydraulic and mechanical brake assemblies can be found together on a utility vehicle, each providing different braking functions. For example a mechanical brake assembly may be coupled to a rear axle for providing parking brake functions while hydraulic brakes assemblies can be coupled to rear wheels for providing conventional braking functions. Implementing one or more mechanical or hydraulic brake assemblies or combination thereof in utility vehicles can require a considerable amount of cable to supply the mechanical force and/or fluid lines to supply the hydraulic fluid.

Electromechanical braking systems, also referred to as brake-by-wire, are now being employed by automobile companies to replace conventional hydraulic and mechanical braking systems. Electromechanical braking systems replace hydraulic or mechanical components with “dry” electrical components. This occurs by replacing the conventional actuators with electric motor driven units. A move to electronic control from hydraulic and/or mechanical eliminates many of the manufacturing, maintenance, and environmental concerns associated with hydraulic and mechanical systems of utility vehicles.

### SUMMARY

Accordingly, a method of providing electric braking for a utility vehicle is provided. The method includes: providing an electric brake assembly including a rotor that is coupled to a rear axle shaft of the utility vehicle, an electric caliper that supplies stopping force to the rotor, and a spring that is pre-loaded to provide an alternative stopping force to the rotor; determining an electrical braking signal based on the brake position signal generated from a brake position sensor coupled to a brake pedal of the utility vehicle; and controlling operation of the electric caliper based on the electrical braking signal.

In other features, an electric braking system for a utility vehicle is provided. The system includes a rotor coupled to a rear axle of the utility vehicle. A caliper is electrically controlled to provide stopping force to the rotor. A spring is pre-loaded to actuate the caliper when additional stopping force is needed. A controller controls the activation of the caliper by generating an electrical braking signal to control operation of the caliper based on a brake position signal generated from a brake pedal position sensor.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a functional block diagram illustrating a utility vehicle including an electric braking system, in accordance with various embodiments.

FIG. 2 is a side perspective view of an electromechanical brake of the electric braking system shown in FIG. 1, in accordance with various embodiments.

FIG. 3 is a data flow diagram illustrating methods and systems of controlling the electric braking system shown in FIG. 1 by a controller, in accordance with various embodiments.

### DETAILED DESCRIPTION OF THE VARIOUS EMBODIMENTS

The following description of various embodiments is merely exemplary in nature and is in no way intended to limit the present teachings, application, or uses.

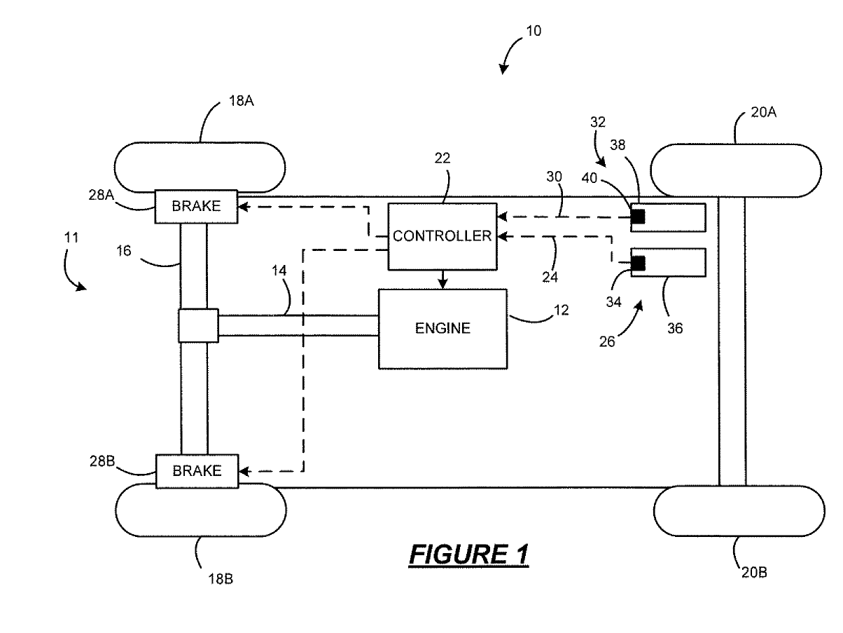

FIG. 1 is a functional block diagram illustrating components of an exemplary light-weight utility vehicle 10 including an electric braking system shown generally at 11, in accordance with various embodiments. An engine 12 is coupled to a drive shaft 14. Drive shaft 14 transfers torque from engine 12 to a rear axle 16 and rear wheels 18A and 18B. A transmission (not shown) may be coupled between engine 12 and drive shaft 14 in order to transfer different levels of torque to rear wheels 18A and 18B. Alternatively, a transaxle may be mounted to engine 12 and to two separate axles (not shown) to transfer different levels of torque to rear wheels 18A and 18B or alternatively to front wheels 20A and 20B.

A controller 22 controls engine 12 based on an accelerator signal 24 received from an accelerator pedal assembly 26. Controller 22 controls electromechanical brakes 28A and 28B mounted to rear wheels 18A and 18B respectively based on a brake signal 30 received from a brake pedal assembly 32. Brake pedal assembly 32 includes a brake pedal 38 and a brake pedal position sensor 40. Brake pedal position sensor 40 generates brake signal 30 based on a sensed position of brake pedal 38. Accelerator pedal assembly 26 includes an accelerator pedal position sensor 34 and an accelerator pedal 36. Accelerator pedal position sensor 34 generates accelerator signal 24 based on a sensed position of accelerator pedal 36.

As can be appreciated, controller 22 may be any known microprocessor or controller known in the art. In an exemplary embodiment, controller 22 is a microprocessor having read only memory (ROM), random access memory (RAM), and a central processing unit (CPU). Controller 22 may include any number of control modules that provide the functionality for controlling electromechanical brakes 28A and 28B of utility vehicle 10 as will be described below. In various other embodiments, controller 22 is an application specific integrated circuit (ASIC), an electronic circuit, a combinational logic circuit and/or other suitable components that provide the electric brake control functionality as described below.

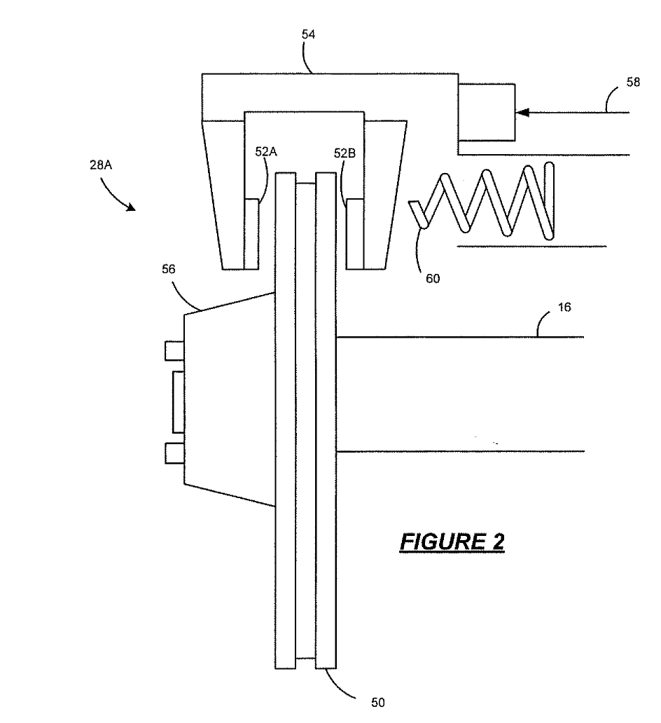

FIG. 2 illustrates electromechanical brake 28A of FIG. 1 in accordance with various embodiments. Electromechanical brake 28A includes a rotor 50, brake pads 52A and 52B, and an electrically controlled caliper 54. Electromechanical brake 28A is mounted to axle 16 via a traditional mounting bracket (not shown). A hub assembly 56 couples to electromechanical brake 28A and provides for attachment of a wheel (not shown). Electrically controlled caliper 54 receives an electrical signal 58 from controller 22 and based on electrical signal 58 causes brake pads 52A and 52B to squeeze rotor 50. When brake pads 52A and 528 contact rotor 50, friction between brake pads 52A and 52B and rotor 50 slow the motion of rotor 50. This causes the rotation of hub assembly 56 coupled to rotor 50 to slow, thereby slowing the motion of the wheel. In various embodiments, electromechanical brake 28A is spring-preloaded via a spring 60 to provide a degree of braking torque in the absence of electrical signal 58. For example, when electrical signal 58 reaches zero volts or is no longer received the lack of electrical current releases the pre-loaded spring to thereby provide additional force to rotor 50 using pad 52B.

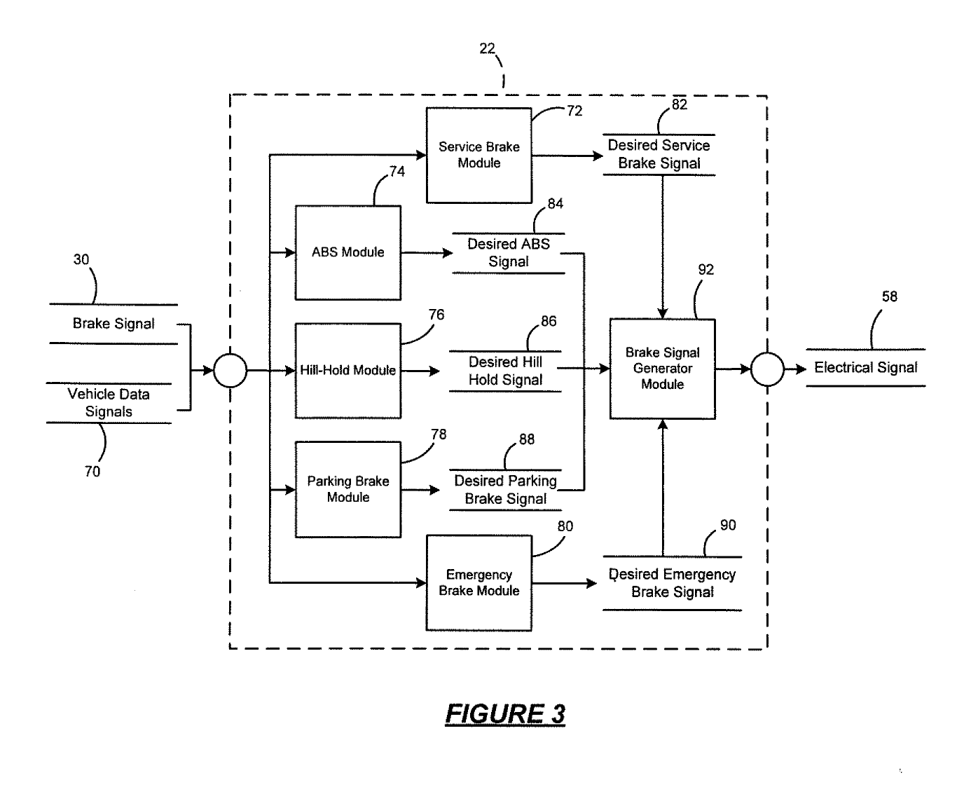

With continued reference to FIG. 2 and additional reference to FIG. 3, controller 22 of FIG. 1 may regulate electrical signal 58 to electromechanical brake utilizing a transistor circuit. Controller 22 provides electrical signal 58 to electromechanical brake 28A based on brake signal 30, and various other data signals 70 (not shown in FIG. 1) received from other sensors at utility vehicle 10 (not shown). Controller 22 provides electrical signal 58 based on control systems or methods, including but not limited to, a service brake control system, an antilock brake system (ABS) control system, a hill-hold control system, a parking brake control system, and an emergency brake control system.

In an exemplary embodiment, the various brake control systems can be implemented as control modules that include algorithms that can be executed by a processor of controller 22 as shown in FIG. 3. Controller 22 can include at least one of a service brake control module 72, an antilock brake control module 74, a hill hold brake control module 76, a parking brake control module 78, and an emergency brake control module 80. Control modules 72-80 each determine a desired brake signal 82-90 as will be discussed further below. A brake signal generator module 92 arbitrates amongst the desired brake signals 82-90 as will be discussed further below to generate electrical signal 58 to electromechanical brakes 28A and/or 28B of FIG. 1.

More particularly, service brake control module 72 determines a desired service brake electrical signal 82 based on a position of brake pedal 38 indicated by brake signal 30. Desired service brake electrical signal 82, when generated by brake signal generator module 92 as electrical signal 58, controls the activation of electromechanical brake 28A.

Antilock brake control module 74 determines a desired ABS electrical signal 84 when a slip of one or more wheels 20A, 20B, 18A and 18B of FIG. 1 is detected and brake signal 30 indicates that brake pedal 38 of FIG. 1 is depressed. A slip of the wheel can be detected from vehicle data signals 70 such as one or more wheel speed sensor signals received from wheel speed sensors (not shown) coupled to hub assemblies of utility vehicle 10. Desired ABS electrical signal 84, when generated as electrical signal 58 by brake signal generator module 92, causes electric caliper 54 of FIG. 2 to rapidly pulse brake pads 52A and 52B against rotor 50 of FIG. 2.

Hill hold brake control module 76 determines a desired hill hold electrical signal 86 when brake signal 30 indicates that brake pedal 38 of FIG. 1 is depressed causing the vehicle to come to a stop and a vehicle torque data 70 indicates a holding torque is necessary to maintain utility vehicle 10 at a stop. Desired hill hold electrical signal 86, when generated as electrical signal 58 by brake signal generator module 92, causes preloaded spring 60 of FIG. 2 of electromechanical brake 28A of FIG. 2 to actuate thereby providing sufficient force to maintain the position of utility vehicle 10 on the hill. In various exemplary embodiments, the actual electrical signal 58 corresponding to desired hill hold electrical signal 86 may be zero volts or no signal at all, so as to actuate spring 60 of electromechanical brake 28A as described above.

Parking brake control module 78 determines a desired parking brake electrical signal 88 based on various vehicle data signals 70 such as a parking brake switch signal indicating to turn on a parking brake function of electromechanical brake 28A. Desired parking brake electrical signal 88, when generated as electrical signal 58 by brake signal generator module 92, causes preloaded spring 60 of electromechanical brake 28A to actuate as discussed above, thereby providing sufficient force to bring utility vehicle 10 to an abrupt stop or to maintain utility vehicle 10 in a stopped position. In an exemplary embodiment, actual electrical signal 58 corresponding to desired parking brake electrical signal 88 may be zero volts or no signal at all so as to actuate spring 60 of electromechanical brake 28A.

Emergency brake control module 80 determines a desired emergency brake electrical signal 90 based on various vehicle data signals 70 such as an emergency shut-off switch signal indicating to actuate an emergency brake function of electromechanical brake 28A. Desired emergency brake electrical signal 90 causes preloaded spring 60 of electromechanical brake 28A to actuate as discussed above thereby providing sufficient force to bring the vehicle to an abrupt stop. In an exemplary embodiment, actual electrical signal 58 corresponding to desired emergency brake electrical signal 90 may be zero volts or no signal at all so as to actuate spring 60 of electromechanical brake 28A.

Brake signal generator module 92 receives desired brake signals 82-90 and applies an arbitration strategy to determine and generate electrical signal 58 to electromechanical brake 28A. An exemplary strategy includes prioritizing desired brake signals 82-90 such that a desired signal with a higher priority is generated if two desired brake signals are received at or near the same time. As can be appreciated, brake signal generator module 92 can similarly generate one or more electrical signals 58 to other electromechanical brakes such as electromechanical brake 28B shown in FIG. 1.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A method of providing electric braking for a utility vehicle, comprising:
providing an electric brake assembly including a rotor that is coupled to a rear axle shaft of the utility vehicle, an electric caliper that supplies stopping force to the rotor, and a spring that is pre-loaded to provide an alternative stopping force to the rotor;
determining an electrical braking signal based on the brake position signal generated from a brake position sensor coupled to a brake pedal of the utility vehicle; and
controlling operation of the electric caliper based on the electrical braking signal.

2. The method of claim 1, the determining the electrical braking signal comprises determining the electrical braking signal based on at least one of an antilock brake control method, a hill-hold control method, a parking brake control method, and an emergency brake control method.

3. The method of claim 1, further comprising:
determining a vehicle speed based on at least one of an accelerator pedal signal generated from an accelerator sensor coupled to an accelerator pedal of the utility vehicle and a wheel speed signal generated from a wheel speed sensor coupled to a hub assembly of the gas utility vehicle; and
the determining the electrical braking signal comprises determining the electrical braking signal based on the brake position signal and the vehicle speed.

4. The method of claim 3, further comprising:
activating the spring of the electric brake assembly if the brake position signal indicates that the brake is depressed and the vehicle speed indicates that the utility vehicle is stopped.

5. The method of claim 1 further comprising:
determining a wheel slip condition based on a wheel speed signal generated from a wheel speed sensor coupled to a hub assembly of the gas utility vehicle; and
the determining comprises determining the electrical braking signal based on the brake position signal and the wheel slip condition.

6. The method of claim 5, the controlling further comprises:
controlling the electric caliper by generating the electrical braking signal to pulse the electric caliper to supply force to the rotor when the brake signal indicates that the brake pedal is depressed and a wheel slip condition is determined.

7. The method of claim 1, further comprising:
receiving a parking brake activation signal generated from a parking brake switch of the utility vehicle; and
the determining the braking signal comprises determining the electrical braking signal based on the parking brake signal.

8. The method of claim 7, further comprising:
activating the spring of the electric brake assembly if the parking brake signal indicates to engage a parking brake function of the electric brake assembly.

9. The method of claim 1, further comprising:
receiving an emergency brake signal generated from an emergency brake switch of the utility vehicle; and
the determining the braking signal comprises determining the electrical braking signal based on the emergency brake signal.

10. The method of claim 9, further comprising:
activating the spring of the electric brake assembly if at least one of the brake position signal and the emergency brake signal indicates to engage an emergency brake function.

11. An electric braking system for a utility vehicle, comprising:
a rotor coupled to a rear axle of the utility vehicle;
a caliper that is electrically controlled to provide stopping force to the rotor;
a spring that is pre-loaded to actuate the caliper when additional stopping force is needed; and
a controller that controls the activation of the caliper by generating an electrical braking signal to control operation of the caliper based on a brake position signal generated from a brake pedal position sensor.

12. The system of claim 11, the controller configured to control the activation of the caliper to perform at least one of a hill hold function, an emergency braking function, a parking brake function, and an antilock braking function.

13. The system of claim 12, the spring is actuated to provide at least one of a hill hold function, an emergency braking function, and a parking brake function when the controller determines that additional stopping force is needed.

14. The system of claim 13, the spring is actuated in the absence of the electrical signal generated from the controller to the caliper.

15. The system of claim 111 the controller configured to regulate the electrical braking signal to electric caliper brake utilizing a transistor circuit.

16. A utility vehicle, comprising:
a left electromechanical brake assembly coupled to a left side of a rear axle of the utility vehicle;
a right electromechanical brake assembly coupled to a right side of the rear axle;
a brake pedal assembly that includes a brake position sensor and a brake pedal and the brake position sensor generates a brake position signal based on a position of the brake pedal; and
a controller that controls the left electromechanical brake assembly and the right electromechanical brake assembly based on the brake position signal.

17. The utility vehicle of claim 16, the left and the right electromechanical brake assemblies comprise:
a rotor coupled to a rear axle of the utility vehicle;
a caliper that is electrically controlled to provide stopping force to the rotor; and
a spring that is pre-loaded to actuate the caliper when additional stopping force is needed.

18. The utility vehicle of claim 16, the controller configured to control the right and the left electromechanical brake assemblies based on at least one of an antilock brake control method, a hill-hold control method, a parking brake control method, and an emergency brake control method.

19. The utility vehicle of claim 16, further comprising:
an accelerator pedal assembly that includes an accelerator pedal and an accelerator pedal position sensor, the accelerator pedal position sensor generates an accelerator signal based on a position of the accelerator pedal position; and
the controller configured to control the left and right electromechanical brake assemblies based on the accelerator signal.

20. The utility vehicle of claim 16, further comprising:
a wheel speed sensor coupled to a hub assembly of the utility vehicle; and
the wheel speed sensor generates a wheel speed signal based on a speed of the wheel coupled to the hub assembly; and
the controller configured to control the left and right electromechanical brake assemblies based on the wheel speed sensor signal.

21. The utility vehicle of claim 16, the controller configured to activate springs of the left and right electromechanical brake assemblies if the parking brake signal indicates to engage a parking brake function of the left and the right electromechanical brake assemblies.

22. The utility vehicle of claim 16, the controller configured to activate springs of the left and right electromechanical brake assemblies if the emergency brake signal indicates to engage an emergency brake function of the left and the right electromechanical brake assemblies.
